(19) United States
(12) Patent Application Publication
(10) Pub. No.: US 2006/0072222 A1
(43) Pub. Date: Apr. 6, 2006

(54) Asymetric, three-dimensional, non-imaging, light concentrator

(76) Inventor: Joseph I. Lichy, San Jose, CA (US)

Correspondence Address: Mark A. Thomas, 10138 South Cottoncreek Drive, Highlands Ranch, CO, 80130-3848, US

(21) Appl. No.: 10/958,778

(22) Filed: Oct. 5, 2004

(51) Int. Cl. G01J 1/20; G01C 21/02; G01C 21/24; G02B 5/10; G02B 5/08

(52) U.S. Cl. 359/853; 359/861

(57) ABSTRACT

A radiant energy concentrator of sunlight adapted for use with a photovoltaic cell. The radiant energy concentrator has a hollow first stage formed by two pairs of facing reflective sides curved to different parabolas. The first stage is optically coupled to a solid second stage with two pairs of facing reflective sides curved to different parabolas. The second stage is optically coupled to a solid light diffuser is some embodiments. The solid light diffuser is optically coupled to the photovoltaic cell with a clear encapsulant. The radiant energy concentrator is mounted on a metal substrate for thermal management. The radiant energy concentrator can operate efficiently with only single axis tracking of the Sun in part because the reflective sides form orthogonal acceptance angles corresponding to the annual and daily apparent passage of the Sun on Earth.

### FIELD OF INVENTION

The present invention relates to concentrating light, more specifically, concentrating light from the Sun onto a photovoltaic surface to convert the concentrated light into electrical energy.

### BACKGROUND

The use of concentrated sunlight in solar energy systems is well known. Most often, however, concentrated light is converted to heat for the generation of steam or hot water. Other light concentrators have been developed for photovoltaic systems which convert light directly to electricity, but these have not been particularly commercially successful.

Light concentrators can be divided into two classes, imaging and non-imaging. An imaging concentrator collects light incident on its front surface, or aperture, and concentrates it at a single focal point. Optical systems that concentrate light in a single dimension, and therefore have a focal line rather than a focal point are also considered imaging. Examples of imaging concentrators are magnifying glasses, parabolic dishes, and Fresnel lenses. Imaging optics require that all collected light be incident close to perpendicular to the aperture of the device. They therefore have the disadvantage of requiring precise alignment, and of not collecting any significant amounts of diffuse light, such as that reflected off clouds, transmitted indirectly through the atmosphere or otherwise diverted from the apparent disk of the Sun. Diffuse sunlight is sunlight arriving indirectly from the Sun.

Non-imaging optics differ from imaging optics as they have no single focal point, but rather have a focal zone, or target, and an acceptance angle. In an ideal non-imaging concentrator, all light incident on the aperture at or below the acceptance angle is transmitted to the target. The ratio between the area of the aperture and the target is termed the “Concentration Factor.” The term “ideal” in relation to non-imaging concentrators further indicates a specific concentration factor equal to n²/sin² α, where n is the index of refraction of the material carrying light at the target, and α is the acceptance angle. Like imaging concentrators, non-imaging concentrators may be designed to concentrate primarily along a single dimension. These are known as two dimensional concentrators (because the profile of the concentrator is two dimensional), or parabolic troughs. An ideal two dimensional concentrator has a concentration factor of n/sin α.

The compound parabolic concentrator described by Roland Winston in 1969, and disclosed in U.S. Pat. No. 3,923,381, is one of the earliest and most successful ideal two dimensional concentrators developed. It is in common use today, and numerous variations to this design are used specifically for heating water and other fluids. However, the parabolic concentrator of Roland Winston and its derivatives are not ideal three-dimensional concentrators. No ideal three-dimensional concentrator has been described to date.

As stated previously, imaging concentrators have two significant disadvantages, i.e., requiring fairly precise alignment with the Sun and not capturing significant amounts of diffuse light. Both disadvantages derive from the fact that only light rays incident perpendicular to the concentrator are focused on the target. This means that the location of the Sun must be tracked with a high degree of precision in order to achieve adequate sunlight concentration, requiring expensive tracking equipment. The additional cost of tracking equipment to the overall imaging concentrator system tends to push the system to very high concentration factors in order to be economical. Since the disk of the Sun is not truly a point, but rather subtends a half angle of approximately 0.25° in the sky, two-dimensional, trough-type imaging concentrators are limited to concentration factors of about 213. A three-dimensional concentrator could provide a more economical system. However, existing three-dimensional imaging concentrators require two-axis tracking of the Sun, further increasing cost and maintenance requirements. Two-axis tracking also presents a problem for locating a system since the typical pole mounted two-axis tracker can not be placed on a building roof unless special consideration has been taken in designing the building. In developed areas it is desirable to place photovoltaic systems on existing structures, and large empty fields are generally not available. Furthermore, even if cost is ignored, the small acceptance angle of imaging concentrators means that diffuse light will be rejected, and not arrive at the target. This is particularly significant on cloudy days, but even a slight haze can spread the Sun's image beyond its normal diameter. This effect has been studied by the National Renewable Energy Lab based in Golden, Colo. (NREL), whose results indicate that imaging concentrators accept about 20% less diffuse light annually than collectors with no concentration in locations as dry as Phoenix, Ariz. Wetter climates suffer more significantly from this problem.

The above two disadvantages have resulted in virtually all imaging solar concentrator systems being large installations (where economies of scale can offset tracking costs) in desert climates.

By allowing the designer to trade off between acceptance angle and concentration factor, non-imaging concentrators resolve many of the issues of imaging concentrators. Two-dimensional, non-imaging concentrators are still bound by the same physical limits as imaging concentrators to a concentration factor of 213. One goal of non-imaging concentrator design has been to eliminate tracking altogether, or at least reduce the tracking requirement to one axis. The literature, e.g., Ari Rabl, Comparison of Solar Concentrators, Solar Energy, Vol. 18 pp. 93-111 (1976), shows that if tracking is to be eliminated, the concentration factor is further limited to 3. Since higher concentration factors are desirable, occasional one axis tracking is generally used. Even under this condition, the concentration factor is limited to about 10.

Despite the disadvantages stated above, light concentrators have been successfully employed in solar thermal applications. At least three concerns exist for the use of concentrators for the generation of electricity using photovoltaic materials.

First, photovoltaic materials are generally highly purified and engineered semiconductors meaning that these materials are generally more expensive than the absorbers used in thermal systems. Since a higher concentration factor means less material can be used to generate the same amount of electricity, there is a strong commercial motivation to increase concentration within acceptable photovoltaic tolerances.

Second, the nature of the semiconductor device employed is that it becomes less efficient (generates less electricity) as its temperature increases. This differs dramatically from thermal systems which are often designed to achieve as high a temperature as possible.

Third, photovoltaic materials perform best under uniform illumination. Non-imaging optics generally produce an undesirable “hot spot” where virtually all light is concentrated on a single point of the target, and the hot spot moves as the angle of the Sun changes.

### SUMMARY

Many of the limitations described above are overcome in accordance with embodiments of the present invention. Some embodiments of the present invention include a light concentrator having a first reflector that is hollow, a second reflector filled with a clear material, a light diffusing element also filled with said clear material, a clear encapsulant sandwiched between an exit portion of the light concentrator and a photovoltaic cell, and a metal substrate supporting both the light concentrator and photovoltaic cell and serving as a heat sink.

### BRIEF DESCRIPTION OF THE DRAWINGS

Other advantages of the invention will become apparent upon reading the following detailed description and upon reference to the accompanying drawings, in which, like references may indicate similar elements:

Drawing Figures

FIG. 1 is a perspective view of the light concentrator;

FIG. 2 is a cross-sectional view of the light concentrator as viewed from the south;

FIG. 3 is a cross-sectional view of the light concentrator as viewed from the east;

FIG. 4 is a function side view of the light concentrator with traces of light rays to illustrate operation of the different sections; and

FIG. 5 is a geometric diagram to illustrate alignment of the light concentrator relative to its location on Earth.

### REFERENCE NUMERALS IN DRAWINGS

100 Light concentrator
110 Hollow reflector
110N North side of hollow reflector
110S South side of hollow reflector
110W West side of hollow reflector
110E East side of hollow reflector
112 Solid reflector
114 Light spreader
116 Target photovoltaic cell
118 Metal substrate
120 Clear encapsulant
122 Conductive tape negative contact
124 Conductive tape positive contact
126 Mounting portion of hollow reflector
128a Flange
128b Flange
130a Bolt
130b Bolt
400 A light ray
402 A light ray parallel to 300
404 Upper surface of solid reflector 112
406 Convergent point near entrance of light spreader
408 Lower surface of light spreader 114
500 Earth
502 Earth's equator
504 Earth's axis of rotation
506 Tilt angle of light collector 100 with horizon
507 Horizon plane
508 Latitude of collector
510 Annual range of apparent location of the Sun

### DETAILED DESCRIPTION

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The written and detailed descriptions herein are designed to enable one of ordinary skill in the art to practice such embodiments.

A light concentrator is provided having several advantages over the prior art. Embodiments of the present invention provide at least one of the following advantages: light concentration capable of a sufficiently high concentration factor to provide a cost and/or performance advantage over use of unconcentrated light with photovoltaic devices; amenability to tracking of the Sun's location along only a single axis; capture of a significant portion of diffuse light and uniform illumination at the target photovoltaic surface. Some embodiments of the present invention provide a light concentrating device that can be economically manufactured in small enough units to simplify the cooling of the target photovoltaic cells. Some embodiments of the present invention couple the concentrator to the photovoltaic cell without requiring manufacturing tolerances that would drive up costs.

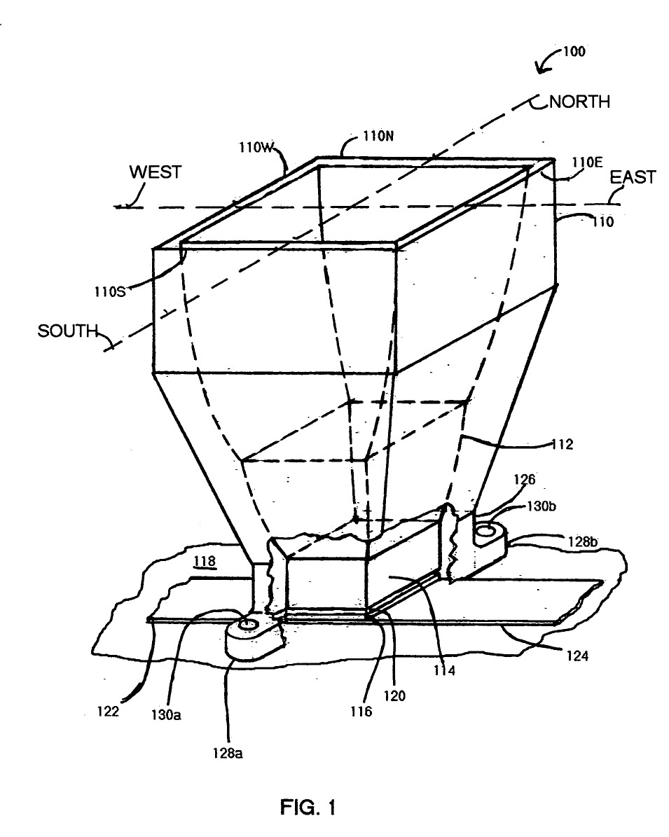

Some embodiments of the light concentrator of the present invention are illustrated in FIG. 1. FIG. 1 shows an asymmetric, three-dimensional, non-imaging, compound parabolic concentrator (CPC) for use as a light concentrator 100. A brief description of the physical relationships between various components of the light concentrator 100 is included here to aid in the understanding of the light concentrator 100 before being described in greater detail. The light concentrator 100 is made up of a hollow reflector 110 drawn as the rectangular-shaped aperture housing of the light concentrator 100. When used to gather sunlight, the hollow reflector 110 is generally oriented along the North-South, East-West axes on Earth as shown in FIG. 1. The hollow reflector 110 has a north side of the hollow reflector 110N and a south side of the hollow reflector 110S which face each other and are symmetrical to each other, but are asymmetrical to an east side of the reflector 110E and a west side of the reflector 110W. The east side 110E and west side 110W pair face each other and are symmetrical to each other. The hollow reflector 110 partially encloses and contains a solid reflector 112 which is positioned lower in the hollow reflector 110 as drawn. Also as drawn, the solid reflector 112 is positioned above a light spreader 114. The light spreader 114 is positioned above a target photovoltaic cell (PV) 116 for generating electricity from light, typically, sunlight. The PV 116 sits on a heat conductive metal substrate 118. The light spreader and PV are optically coupled with a clear encapsulant 120. The PV 116 is electrically coupled to a negative conductive tape 122 and a positive conductive tape 124 to provide electrical power. The hollow reflector has a mounting portion 126 that includes flanges 128a, 128b forming apertures for bolting the hollow reflector 110 to the metal substrate 118 with bolts 130a, 130b.

Although the light concentrator is drawn pointing straight up, in the Northern Hemisphere, the light concentrator 100 would be pointed in a more southerly direction depending on the latitude the light concentrator 100 is to be placed at, which corresponds to the apparent location of the passage of the Sun through the sky as the Earth rotates. While in the Southern Hemisphere, the light concentrator 100 would be pointed in a more northerly direction for the same reason. Note that all orientations referred to herein are included for illustration purposes only and are not intended to be limiting.

Hollow reflector 110 has the form of two intersecting orthogonal compound parabolic concentrator troughs of the general types used separately in the prior art. The compound parabolic concentrator with its axis in the east-west direction is formed by inner sides of the north side 110N and south side 110S of hollow reflector 110 with an acceptance half angle of approximately 35°, which can allow for light collection without any tracking for 6 hours/day. The compound parabolic concentrator with its axis in the north-south direction is formed by sides 110E and 110W which together form a compound parabolic concentrator with an acceptance half angle of approximately 53°. The walls of the reflector formed by the inner portion of the east side 110E and the west side 110W are extended vertically to the same height of the compound parabolic concentrator formed by the north side 110N and south side 110S to form an entrance aperture 120 in the hollow concentrator 110. The entrance aperture 120 has an even edge on all four sides 110N, 110S, 110W, 110E.

In some embodiments, the hollow reflector 110 is a molded or vacuum-formed thermosetting plastic with the inside coated with a highly reflective material. In some embodiments, the base plastic material selected for its chemical and thermal stability in the hollow reflector 110 is Lustran® ABS Resin 348 from the Plastics Division of Bayer, Inc., Bayer Group, Leverkusen, Germany. In some embodiments the plastic is coated with aluminum deposited by vacuum metallization to achieve a reflectance on the order of 93%. However, the hollow reflector 110 may be made of any materials that can be formed into this shape and made to be highly reflective, such as metal, glass, other plastics, etc.

At the lower, narrow end of the hollow reflector 110, as drawn, is the solid reflector 112. The shape of the solid reflector 112 is also that of two intersecting CPC troughs. In some embodiments, the outer reflective walls of the solid reflector 112 are formed of the aluminum deposited by vacuum metallization similar to that of the inner portions of the hollow reflector 110. The solid reflector 112 includes a clear solid having an index of refraction greater than one and in some embodiments, between 1.48 and 1.52. In some embodiments the solid reflector 112 is made of UV-enhanced polymethylmethacrylate Acrylic (PMMA). In some embodiments, the PMMA used in the solid reflector 112 is Atoglas VH Plexiglas produced by Atofina Chemicals, Inc., Philadelphia, Pa. However, in other embodiments the solid reflector 112 can be fabricated from materials such as glass or polycarbonate plastic, which are substituted for PMMA.

The acceptance half angle of the CPC's forming the solid reflector 112 is set to arcsin(1/n) where n is the index of refraction of the solid material. This angle is equal to the angle of refraction of a light ray in the solid material cause by a ray incident on the solid surface with an angle of incidence of 90°.

At the narrow end of the solid reflector 112 is the light spreader 114. Below the light spreader is the photovoltaic (PV) cell 116 that converts some of the light exiting the light spreader into electricity. The light spreader 114 has square top, base and vertical sides. In some embodiments, the vertical sides of the light spreader 114 are coated with the same reflective material as those of the hollow reflector 110 and solid reflector 112, e.g., aluminum. Also in some embodiments, the light spreader 114 is fabricated from the same clear material as the solid reflector 112, e.g., PMMA. An alternative clear material can be used in the light spreader 114, but in some embodiments an index of refraction associated with the alternative clear material is nearly equal to or greater than that of the solid reflector 112. In some embodiments, the hollow reflector 110 and outside reflective walls of the solid reflector 112 and light spreader 114 are fabricated as a single piece, while the solid filler material of the solid reflector 112 and light spreader 114 are likewise fabricated as a second single piece, the solid piece fitting snuggly inside the hollow piece. In some alternative embodiments, each section can be fabricated separately or in other combinations and assembled to form the same final structure. In some alternative embodiments, the base side of the solid light spreader 114, being positioned furthest from the light-receiving aperture of the hollow reflector 110, is recessed slightly inward to form a cavity for the PV cell 116. The depth of the cavity in the base side of the solid light spreader 114 is equal to, or slightly greater than the height of the target PV cell 116. In still further alternative embodiments the light spreader 114 is not used and the PV cell 116 is optically coupled with the clear encapsulant 120 directly to the solid reflector 112.

Between the target PV cell 116 and the base of the light spreader 114 is clear encapsulant 120, which fills the space between the target PV cell 116 and the light spreader 114. The clear encapsulant 120 has two primary purposes. First, the clear encapsulant 120 optically couples the light spreader 114 to the PV cell 116. Second, the clear encapsulant 120 encapsulates and protects those portions of the light spreader 114 and PV cell 116 that the clear encapsulant comes in contact with from environmental contaminants. While any number of materials may be used as the encapsulant 120, it is desirable for the encapsulant 120 to have a high degree of clarity, be capable of being deposited in a thin layer and have a refractive index compatible with the light spreader 114. In some embodiments the clear encapsulant 120 is Lightspan SL-1246 optical coupling gel (thixotropic) from Lightspan, LLC, 14 Kendrick Road, Unit #2, Wareham, Mass. In other embodiments, Sylgard 184 Silcone rubber from The Dow Chemical Company, 901 Loveridge Road, Pittsburg, Calif. or the Nye Optical OCK451 curable adhesive from Nye Optical Company, 10309 Centinella Drive, La Mesa, Calif., can be used as the encapsulant 120. In some alternative embodiments, a combination of Ethylene Tetrafluoroethylene (ETFE, also known as TEFLON®) and ethylene vinyl acetate (EVA) is used, which provides good matching of the index of refraction to PMMA, and resistance to yellowing due to exposure to sunlight, which is a problem for EVA when used alone. For example, the ETFE and EVA can be combined by layering or blending.

The clear encapsulant 120 is applied in a thin layer to the PV 116 as a gel. The PV 116 is then brought into contact with the light spreader 114 and the clear encapsulant 120 is allowed to harden by exposure to air. In some embodiments the clear encapsulant 120 is cured to a desired hardness. In this way the target PV 116 is optically coupled to the light spreader 114, otherwise, light could reflect off of an air gap between the light spreader 114 and the cell 116, decreasing overall efficiency. Once the clear encapsulant 120 has been hardened through exposure to air or curing, the clear encapsulant 120 optically couples and protects the PV 116 and light spreader 114. The clear encapsulant 120 also seals the bottom of the hollow reflector 110 to the metal substrate 118.

Electrical connection is made to the PV cell 116 through conductive tapes, more specifically, negative terminal conductive tape 122 and positive terminal conductive tape 124. The negative terminal 122 and the positive terminal 124 pass through slots in a mounting portion 126 of the hollow reflector 110.

In many embodiments, the mounting portion 126 of the hollow reflector 110 includes flanges 128a, 128b forming apertures to enable the hollow reflector 110 to be mechanically secured to the metal substrate 118 with bolts 130a, 130b. Alternatively, any form of attachment between the hollow reflector 110 and the metal substrate 118 can be used such as screws, magnets, mating surfaces, adhesives or the like. Because the hollow reflector 110 is mechanically secured to the metal substrate, the PV 116 is correspondingly held in thermal contact with the metal substrate 118. Having the PV 116 in thermal contact with the metal substrate 118 enables excess heat to be carried away from the PV 116 for effective thermal management. A thin layer of Kapton electrically insulates the back of PV 116 from the metal substrate 118. In some embodiments the metal substrate is aluminum, but other suitable heat conductive materials that can withstand the environment may also be used. Note that PV 116 is held in contact with the metal substrate 118 through the bolts 130a, 130b securing the hollow reflector 110 to the metal substrate 118.

In some embodiments, the light concentrator 100 is positioned in an array of light concentrators 100 that are covered with Plexiglas® covers to protect the array from environmental contaminants such as rain, snow and debris. In some embodiments, each individual light concentrator is covered with its own Plexiglas® cover.

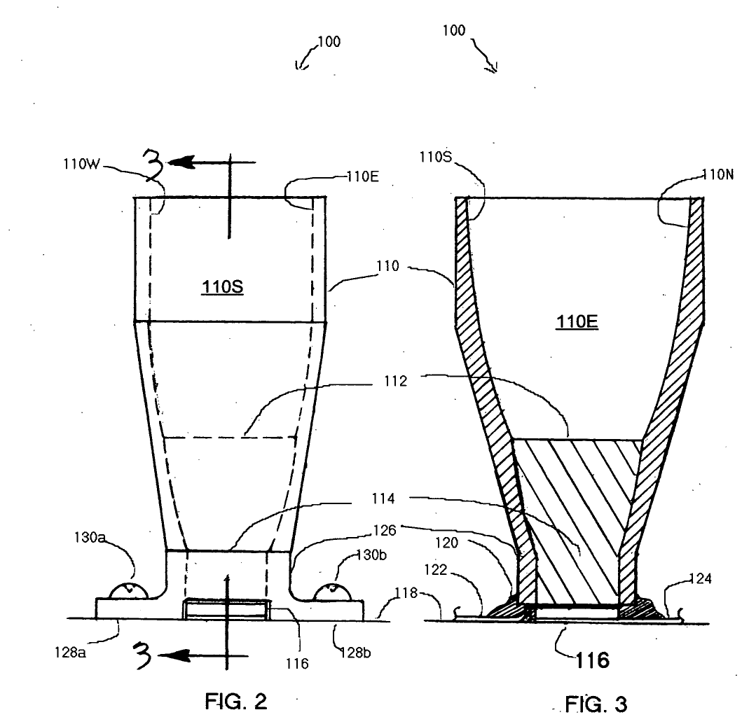

Turning now to FIG. 2 and FIG. 3, in FIG. 2, there is shown a partial, cross-sectional view of the light concentrator 100 as viewed from the south towards the north, i.e. facing into the south side of the light concentrator 110S. The south side 110S is shown in partial cross-section to reveal portions of the west face 110W and east face 110E, otherwise shown with dashed lines. The numbered components in FIG. 1 are also present in both FIG. 2 and FIG. 3, but some have been removed in these figures for clarity purposes. FIG. 3 shows a full cross-sectional view of the light concentrator 100 as viewed from the east towards the west from the section line in FIG. 2, i.e. facing into the east side of the light concentrator 110E. In FIG. 2 and FIG. 3, one can more easily perceive the four different parabolic curves in the light concentrator 100 that define the inner reflective surfaces of the hollow reflector 110 and the outer reflector surfaces of the solid reflector 112, respectively. In some embodiments those parabolic curves are specified in the following table where the length dimensions are in centimeters and the angles are in degrees.

| Concentrator | | | | |
|---|---|---|---|---|
| Sides | Hollow or | | | |
| Forming | Solid | | | Incl. |
| Parabola | Reflector | Equation | X Range | Angle |
| North-South | Hollow 110 | Y = 0.106 X\hat{ }2 | 2.457 < | 35 |
| | | | X < 6.742 | |
| East-West | Hollow 110 | Y = 0.093 X\hat{ }2 | 1.805 < | 53 |
| | | | X < 4.066 | |
| North-South | Solid 112 | Y = 0.150 X\hat{ }2 | 1.491 < | 41.8 |
| | | | X < 3.727 | |
| East-West | Solid 112 | Y = 0.150 X\hat{ }2 | 1.491 < | 41.8 |
| | | | X < 3.727 | |

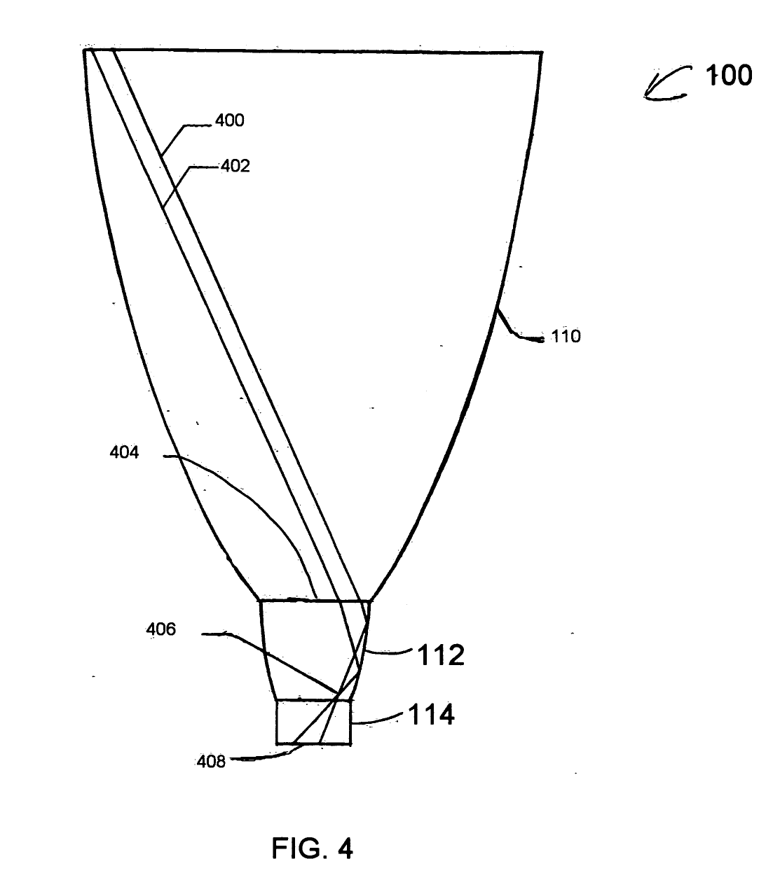

Turning now to FIG. 4, there is shown a functional side view of the light concentrator 100 with two example light rays, 400 and 402, respectively. In this example the two rays 400, 402 are parallel and displaced from one another by a small distance. After traveling from the Sun through space and the Earth's atmosphere, the light rays 400, 402 pass through hollow reflector 110 without contacting the walls 110N, 110S, 110W, 110E of the hollow reflector 110. The two rays 400, 402 are refracted at an upper surface 404 of the solid reflector 112, changing their angle as described by Snell's Law, but continue parallel to each other inside the clear material. Next the rays 400, 402 are incident on the outer reflective walls of the solid reflector 112 at different points, and are reflected to converge at point 406 near where they enter light spreader 114. Since the index of refraction of the solid reflector 112 and the light spreader 114 are essentially the same, the rays 400, 402 continue in straight lines into and through the light diffuser 114, diverge, and exit the light spreader 114 at different locations along a lower surface 408 of the light spreader 114 with different angles. Because the clear encapsulant 120 has an index of refraction similar to that of the said light spreader, little refraction occurs as said light rays pass from surface 408 into the encapsulant 120 and through the encapsulant 120 to the target PV cell 116 to generate electricity. The presence of the clear encapsulant 120 prevents the formation of a significant air gap between the light spreader 114 and the target PV cell 116 which in turn prevents significant light loss that could have occurred due to internal reflection at surface 408, reducing the performance of the concentrator significantly.

In the case of parallel light rays incident on the walls 110N, 110S, 110W, 110E of the hollow reflector 110, the rays tend to converge at a point on surface 404 of solid reflector 112, and produce a uniform illumination at the entrance of said light spreader 114, with many rays being near parallel at this point. Since the rays are neither diverging nor converging the uniformity of the illumination will continue through surface 408, through the clear encapsulant and onto the surface of the target PV cell 116.

In the case of light incident at or near the acceptance angle in both the North-South and East-West directions, if the light is subject to multiple reflections it may be reflected back out the aperture, however, this accounts for a relatively small loss of light.

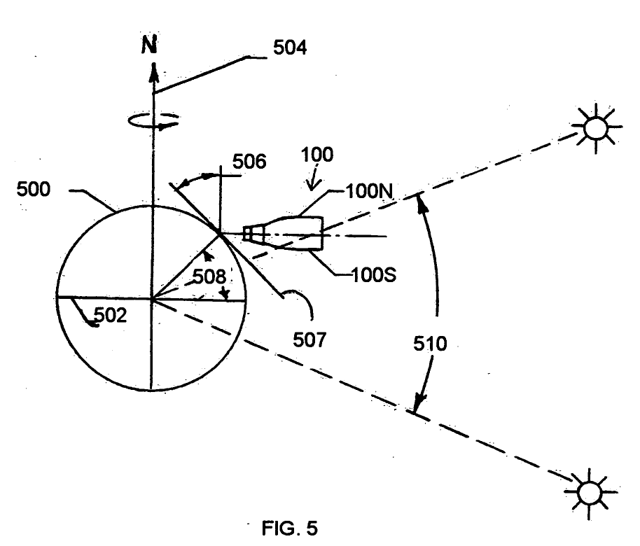

Turning now to FIG. 5, there is shown a geometric diagram to illustrate alignment of the light concentrator relative to its location on Earth. Alignment of the asymmetric light concentrator 100 for optimal performance using single (east-west) axis tracking throughout the year is shown. The Earth 500 is represented by a circle having an equator 502 and being oriented along a north-south spin axis 504. The light concentrator 100 is located on the surface of the Earth at a latitude given by angle 508. The light concentrator 100 has its north side 110N facing north and its south face 110S facing south, as indicated by the north-south axis 504. The light concentrator 100 is shown in FIG. 5 at local noon time. Note that the drawing is not to scale and the image of the light concentrator 100 is vastly enlarged for clarity purposes. The range of relative motion of the Sun throughout the year is given by angle 510. The light concentrator 100 is tilted up at angle 506 from the horizon plane 507, with tilt angle 506 being equal to latitude angle 508. The resulting configuration results in the North-South axis of the light concentrator 100 being parallel to Earth's rotational, or polar axis 504. Because the light concentrator 100 is aligned to the center of the apparent range of the Sun throughout the year at the latitude the light concentrator 100 is placed at, so long as the light concentrator 100 is allowed to rotate around its North-South axis, it will concentrate the available sunlight from the Sun during all daylight hours during every day of the year.

Thus has been described an asymmetric, three-dimensional, non-imaging, light concentrator. In some embodiments, the asymmetric nature of the hollow reflector 110 enables an advantageous concentration factor to be achieved with only single axis tracking of the Sun without the need for seasonal adjustment as the acceptance angle in the north-south direction is greater than the range of the sun's azimuth. In some embodiments solid reflector 112 boosts the concentration factor by about 2.25 while using a relatively minimal amount of material. In some embodiments the light spreader produces uniform illumination on the PV cell 116. In some embodiments the encapsulant 120 interface between the light diffuser 114 and the PV cell 116 allows for less precise manufacturing tolerances without degraded performance. In some embodiments the rectangular aperture of the light concentrator 100 allows for tight packing of multiple concentrators in a module. In some embodiments the simple two piece (hollow and solid reflectors 110, 112) design of the light concentrator 100 allows for low cost manufacturing of small units. In some embodiments the metal substrate in proximity to the target PV cell 116 allows for effective thermal management.

Although the description above contains many specificities, these should not be construed as limiting the scope of the invention, but as merely providing illustration of the preferred embodiment of this invention. For example, different acceptance angles may be chosen for the hollow reflector. This may be appropriate in locations with a high fraction of diffuse light. The use of glass instead of PMMA for the clear material of the solid reflector 112 and light spreader 114, while heavy and more expensive, may be advantageous because of its greater thermal stability, and ability to conduct heat away from the target PV 116. For similar reasons, metals may be used to replace the reflective sides of the light concentrator. The encapsulant 120 filling the space between the light concentrator and the target PV cell may be omitted in cases where fine tolerances allow for the precise abutment of the light concentrator and the target PV cell.

It is understood that the forms of the invention shown and described in the detailed description and the drawings are to be taken merely as examples. It is intended that the following claims be interpreted broadly to embrace all the variations of the example embodiments disclosed herein. Thus the scope of the invention should be determined by the appended claims and their legal equivalents, rather than by the examples given.

What is claimed is:

1. A radiant energy concentrator, comprising:
a first pair of facing reflective sides positioned around a first axis, the first pair of facing reflective sides having a proximal end and a distal end, the first pair of facing reflective sides forming an aperture at the distal end to receive radiant energy, the radiant energy being concentrated by the first pair of facing reflective sides at the proximal end, the first pair of facing reflective sides having a first curvature; and
a second pair of facing reflective sides positioned around a second axis, the second pair of facing reflective sides having a proximal end and a distal end, the second pair of facing reflective sides forming an aperture at the distal end to receive radiant energy, the radiant energy being concentrated by the second pair of facing reflective sides at the proximal end, wherein the distal end of the first pair of facing reflective sides is positioned adjacent to and at least partially transversely with the distal end of the second pair of reflective sides, the second pair of reflective sides having a second curvature, wherein the first curvature is different than the second curvature.

2. The radiant energy concentrator of claim 1 wherein the first curvature is a compound parabola and the second curvature is a compound parabola.

3. The radiant energy concentrator of claim 1 wherein the first axis is generally aligned with the north-south longitudinal axis of the Earth and the second axis is generally aligned with an east-west latitudinal axis for a location of the radiant energy concentrator on the Earth.

4. The radiant energy concentrator of claim 1 wherein first and second pairs of reflecting sides are formed as a single piece.

5. The radiant energy concentrator of claim 4 wherein the single piece is made of plastic coated with a reflective material.

6. A radiant energy concentrator, comprising:
a first reflector, the first reflector having a first pair of facing reflective sides at least partially curved to form a first curvature and a second pair of facing reflective sides at least partially curved to form a second curvature, the first reflector having a distal aperture for receiving radiant energy, the radiant energy being concentrated into concentrated radiant energy by the first reflector and the first reflector having a proximal aperture for transmitting the concentrated radiant energy, wherein the first curvature is different than the second curvature; and
a second reflector, the second reflector having a distal end optically coupled to the proximal end of the first reflector to receive concentrated radiant energy from the first reflector, the concentrated radiant energy being further concentrated into further concentrated radiant energy by the second reflector, the second reflector having a proximal end for transmitting the further concentrated radiant energy, the second reflector having a third pair of facing reflective sides at least partially curved to form a third curvature and a fourth pair of facing reflective sides at least partially curved to form a fourth curvature, wherein the third curvature and the fourth curvature are different than the first curvature and the second curvature.

7. The radiant energy concentrator of claim 6 wherein the first curvature is a compound parabola, the second curvature is a compound parabola, the third curvature is a compound parabola and the fourth curvature is a compound parabola.

8. The radiant energy concentrator of claim 6 wherein the first pair of reflecting sides and the third pair reflecting sides are generally aligned with the north-south longitudinal axis of the Earth and the second pair of reflecting sides and the fourth pair of reflecting sides are generally aligned with an east-west latitudinal axis for a given location of the radiant energy concentrator on Earth.

9. The radiant energy concentrator of claim 6 wherein the first reflector is hollow and the second reflector contains a solid material.

10. The radiant energy concentrator of claim 9 wherein the solid material is polymethylmethacrylate Acrylic (PMMA).

11. The radiant energy concentrator of claim 6 wherein the first reflector is hollow and the second reflector contains a material having an index of refraction greater than 1.

12. The radiant energy concentrator of claim 6 wherein the first reflector is hollow and the second reflector contains a material having an index of refraction between 1.48 and 1.52.

13. The radiant energy concentrator of claim 6 wherein the second reflector contains polymethylmethacrylate Acrylic (PMMA) coated with a reflective coating.

14. The radiant energy concentrator of claim 13 wherein the reflective coating is aluminum deposited by vacuum metallization.

15. A radiant energy concentrator, comprising:
a first reflector, the first reflector having a first pair of facing reflective sides at least partially curved to form a first curvature and a second pair of facing reflective sides at least partially curved to form a second curvature, the first reflector having a distal aperture for receiving radiant energy, the radiant energy being concentrated into concentrated radiant energy by the first reflector and the first reflector having a proximal aperture for transmitting the concentrated radiant energy, wherein the first curvature is different than the second curvature; and
a second reflector, the second reflector having a distal end optically coupled to the proximal end of the first reflector to receive concentrated radiant energy from the first reflector, the concentrated radiant energy being further concentrated into further concentrated radiant energy by the second reflector, the second reflector having a proximal end for transmitting the further concentrated radiant energy, the second reflector having a third pair of facing reflective sides at least partially curved to form a third curvature and a fourth pair of facing reflective sides at least partially curved to form a fourth curvature, wherein the third curvature and the fourth curvature are different than the first curvature and the second curvature; and
a light spreader, the light spreader optically coupled to the proximal end of the second reflector.

16. The radiant energy concentrator of claim 15 wherein the first curvature is a compound parabola, the second curvature is a compound parabola, the third curvature is a compound parabola and the fourth curvature is a compound parabola.

17. The radiant energy concentrator of claim 15 wherein the first pair of reflecting sides and the third pair reflecting sides are generally aligned with the north-south longitudinal axis of the Earth and the second pair of reflecting sides and the fourth pair of reflecting sides are generally aligned with an east-west latitudinal axis for a given location of the radiant energy concentrator on Earth.

18. The radiant energy concentrator of claim 15 wherein the first reflector is hollow and the second reflector contains a solid material.

19. The radiant energy concentrator of claim 18 wherein the solid material is polymethylmethacrylate Acrylic (PMMA).

20. The radiant energy concentrator of claim 15 wherein the first reflector is hollow and the second reflector contains a material having an index of refraction greater than 1.

21. The radiant energy concentrator of claim 15 wherein the first reflector is hollow and the second reflector contains a material having an index of refraction between 1.48 and 1.52.

22. The radiant energy concentrator of claim 15 wherein the second reflector contains polymethylmethacrylate Acrylic (PMMA) coated with a reflective coating.

23. The radiant energy concentrator of claim 22 wherein the reflective coating is aluminum deposited by vacuum metallization.

24. A radiant energy concentrator, comprising:
a first reflector, the first reflector having a first pair of facing reflective sides at least partially curved to form a first curvature and a second pair of facing reflective sides at least partially curved to form a second curvature, the first reflector having a distal aperture for receiving radiant energy, the radiant energy being concentrated into concentrated radiant energy by the first reflector and the first reflector having a proximal aperture for transmitting the concentrated radiant energy, wherein the first curvature is different than the second curvature;
a second reflector, the second reflector having a distal end optically coupled to the proximal end of the first reflector to receive concentrated radiant energy from the first reflector, the concentrated radiant energy being further concentrated into further concentrated radiant energy by the second reflector, the second reflector having a proximal end for transmitting the further concentrated radiant energy, the second reflector having a third pair of facing reflective sides at least partially curved to form a third curvature and a fourth pair of facing reflective sides at least partially curved to form a fourth curvature, wherein the third curvature and the fourth curvature are different than the first curvature and the second curvature;
a light spreader, the light spreader optically coupled to the proximal end of the second reflector; and
a photovoltaic cell, the photovoltaic cell optically coupled to the light spreader with a clear encapsulant.

25. The radiant energy concentrator of claim 24 wherein the first curvature is a compound parabola, the second curvature is a compound parabola, the third curvature is a compound parabola and the fourth curvature is a compound parabola.

26. The radiant energy concentrator of claim 24 wherein the clear encapsulant is capable of being deposited in a thin layer.

27. The radiant energy concentrator of claim 26 wherein the clear encapsulant is selected from: Lightspan SL-1246 optical coupling gel, Sylgard 184 Silcone rubber, Nye Optical OCK451 curable adhesive, and a combination of Ethylene Tetrafluoroethylene (ETFE) and ethylene vinyl acetate (EVA).

28. A radiant energy concentrator, comprising:
a first reflector, the first reflector having a first pair of facing reflective sides at least partially curved to form a first curvature and a second pair of facing reflective sides at least partially curved to form a second curvature, the first reflector having a distal aperture for receiving radiant energy, the radiant energy being concentrated into concentrated radiant energy by the first reflector and the first reflector having a proximal aperture for transmitting the concentrated radiant energy, wherein the first curvature is different than the second curvature;
a second reflector, the second reflector containing a solid medium, the second reflector having a distal end optically coupled to the proximal end of the first reflector to receive concentrated radiant energy from the first reflector, the concentrated radiant energy being further concentrated into further concentrated radiant energy by the second reflector, the second reflector having a proximal end for transmitting the further concentrated radiant energy, the second reflector having a third pair of facing reflective sides at least partially curved to form a third curvature and a fourth pair of facing reflective sides at least partially curved to form a fourth curvature, wherein the third curvature and the fourth curvature are different than the first curvature and the second curvature; and
a photovoltaic cell, the photovoltaic cell optically coupled to the solid medium with a clear encapsulant.

29. The radiant energy concentrator of claim 28 wherein the first curvature is a compound parabola, the second curvature is a compound parabola, the third curvature is a compound parabola and the fourth curvature is a compound parabola.

30. The radiant energy concentrator of claim 28 wherein the clear encapsulant is capable of being deposited in a thin layer.

31. The radiant energy concentrator of claim 28 wherein the clear encapsulant is selected from: Lightspan SL-1246 optical coupling gel, Sylgard 184 Silcone rubber, Nye Optical OCK451 curable adhesive, and a combination of Ethylene Tetrafluoroethylene (ETFE) and ethylene vinyl acetate (EVA).

32. A radiant energy concentrator, comprising:
a first pair of facing reflective sides positioned around a first axis in a solid medium, the first pair of facing reflective sides having a proximal end and a distal end, the first pair of facing reflective sides forming an aperture at the distal end to receive radiant energy, the radiant energy being concentrated by the first pair of facing reflective sides at the proximal end, the first pair of facing reflective sides having a first curvature;
a second pair of facing reflective sides positioned around a second axis in the solid medium, the second pair of facing reflective sides having a proximal end and a distal end, the second pair of facing reflective sides forming an aperture at the distal end to receive radiant energy, the radiant energy being concentrated by the second pair of facing reflective sides at the proximal end, wherein the distal end of the first pair of facing reflective sides is positioned adjacent to and at least partially transversely with the distal end of the second pair of reflective sides, the second pair of reflective sides having a second curvature, wherein the first curvature is different than the second curvature; and
a photovoltaic cell, the photovoltaic cell optically coupled to the solid medium with a clear encapsulant.

33. The radiant energy concentrator of claim 32 wherein the first curvature is a compound parabola and the second curvature is a compound parabola.

34. The radiant energy concentrator of claim 32 wherein the clear encapsulant is capable of being deposited in a thin layer.

35. The radiant energy concentrator of claim 32 wherein the clear encapsulant is selected from: Lightspan SL-1246 optical coupling gel, Sylgard 184 Silcone rubber, Nye Optical OCK451 curable adhesive, and a combination of Ethylene Tetrafluoroethylene (ETFE) and ethylene vinyl acetate (EVA).

36. A radiant energy concentrator, comprising:
a light spreader, the light spreader containing a solid medium and having reflective sides forming a distal aperture to receive concentrated radiant energy and a proximal aperture to transmit the concentrated radiant energy; and
a photovoltaic cell, the photovoltaic cell optically coupled with a clear encapsulant to the proximal aperture of the light spreader, the photovoltaic cell adapted to receive concentrated radiant energy from the light spreader and to convert the concentrated radiant energy into electrical power.

37. The radiant energy concentrator of claim 36 wherein the clear encapsulant is capable of being deposited in a thin layer.

38. The radiant energy concentrator of claim 37 wherein the clear encapsulant is selected from: Lightspan SL-1246 optical coupling gel, Sylgard 184 Silcone rubber, Nye Optical OCK451 curable adhesive, and a combination of Ethylene Tetrafluoroethylene (ETFE) and ethylene vinyl acetate (EVA).

39. A radiant energy concentrator, comprising:
a solid reflector, the solid reflector having a first pair of facing reflective sides at least partially curved to form a first curvature and a second pair of facing reflective sides at least partially curved to form a second curvature, the solid reflector having a distal aperture for receiving radiant energy, the radiant energy being concentrated into concentrated radiant energy by the solid reflector and the solid reflector having a proximal aperture for transmitting the concentrated radiant energy;
a light spreader, the light spreader optically coupled to the proximal end of the second reflector; and
a photovoltaic cell, the photovoltaic cell optically coupled to the light spreader with a clear encapsulant.

40. The radiant energy concentrator of claim 24 wherein the first curvature is a compound parabola and the second curvature is a different compound parabola.

41. The radiant energy concentrator of claim 24 wherein the clear encapsulant is capable of being deposited in a thin layer.

42. The radiant energy concentrator of claim 26 wherein the clear encapsulant is selected from: Lightspan SL-1246 optical coupling gel, Sylgard 184 Silcone rubber, Nye Optical OCK451 curable adhesive, and a combination of Ethylene Tetrafluoroethylene (ETFE) and ethylene vinyl acetate (EVA).
